(19) United States
(12) Patent Application Publication
(10) Pub. No.: US 2006/0101646 A1
(43) Pub. Date: May 18, 2006

(54) Method for making a metallic building structure and the metallic building structure made thereby

(76) Inventor: Yau-Liang Jhang, Taichung City (TW)

Correspondence Address: FOLEY AND LARDNER LLP;SUITE 500, 3000 K STREET NW, WASHINGTON, DC, 20007, US

(21) Appl. No.: 10/990,512

(22) Filed: Nov. 18, 2004

(51) Int. Cl. B23P 15/12; E04H 12/00

(52) U.S. Cl. 29/897.31; 52/653.2; 52/633

(57) ABSTRACT

A method for making a metallic building structure having at least one metal rail connected to a plurality of posts includes the steps of inserting one end of at least one of the posts into an insert hole of the metal rail, inserting a pin through the metal rail and the end of the at least one of the posts until two opposite ends of the pin protrude from two opposite sides of the metal rail, welding the ends of the pin to the metal rail, grinding welded parts of the pin and the metal rail so as to provide a smooth surface, and conducting an anti-rusting surface treatment on the metal rail and the at least one of the posts.

### BACKGROUND OF THE INVENTION

1. Field of the Invention

The invention relates to a method for making a metallic building structure, more particularly to a method for making a metallic building structure which has at least one metal rail connected to a plurality of posts. The invention also relates to a metallic building structure made thereby.

2. Description of the Related Art

Referring to FIG. 1, a conventional metallic railing 1 includes two metal rails 101 and a plurality of parallel metal balusters 102. Each of the metal balusters 102 has two ends connected respectively to the metal rails 101 by welding. However, the appearance of the conventional metallic railing 1 is marred by welding traces 103 at joints between the metal rails 101 and the balusters 102. Although the welding traces 103 can be removed by grinding so as to enhance the appearance of the conventional metallic railing 1, it is not easy to grind the welding traces 103 at the joints. Furthermore, the strength of connection between the balusters 102 and the metal rails 101 may be adversely affected due to grinding.

In another conventional metallic railing structure, balusters are connected to metal rails using screws. However, parts of the screws will protrude from outer surfaces of the metal rails, thereby marring the appearance of the railing structure. Furthermore, as the screws are liable to loosen, the fastening strength thereof will be insufficient.

### SUMMARY OF THE INVENTION

The object of the present invention is to provide a method for making a metallic building structure which has an integral appearance and improved fastening strength.

Accordingly, in one aspect of this invention, a method for making a metallic building structure having at least one metal rail connected to a plurality of posts includes the steps of:

a) inserting one end of at least one of the posts into an insert hole of the metal rail;

b) inserting a pin through the metal rail and the end of the at least one of the posts such that two opposite ends of the pin protrude from two opposite sides of the metal rail;

c) welding the ends of the pin to the metal rail;

d) grinding welded parts of the pin and the metal rail so as to provide a smooth surface; and

e) conducting an anti-rusting surface treatment on the metal rail and the at least one of the posts.

In another aspect of this invention, a metallic building structure includes at least one metal rail, a plurality of posts, and a plurality of pins. The metal rail has a plurality of insert holes. Each of the posts has an end inserted into one of the insert holes. Each of the pins is inserted through the at least one metal rail and the end of a corresponding one of the posts. The pins have two ends flush with an outer surface of the metal rail.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary perspective view of a conventional metallic building structure;

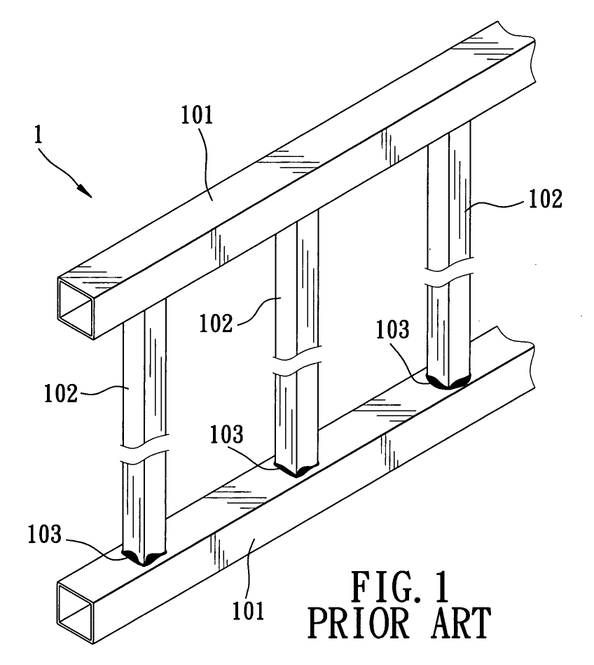

FIG. 2 is a flow diagram of the preferred embodiment of a method for making a metallic building structure according to this invention;

FIG. 3 is a fragmentary sectional perspective view of the preferred embodiment of a metallic building structure according to this invention; and

FIG. 4 is a fragmentary sectional view of the preferred embodiment of FIG. 3.

### DETAILED DESCRIPTION OF THE PREFERRED EMBODIMENTS

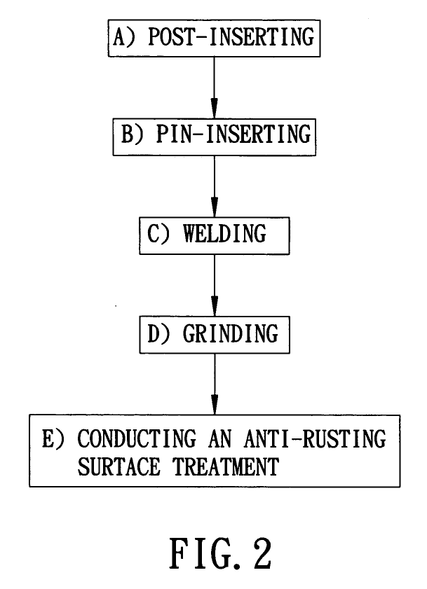

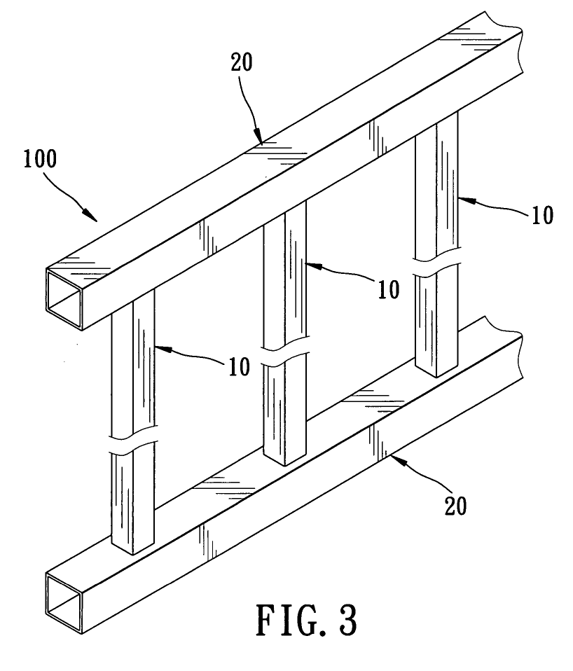

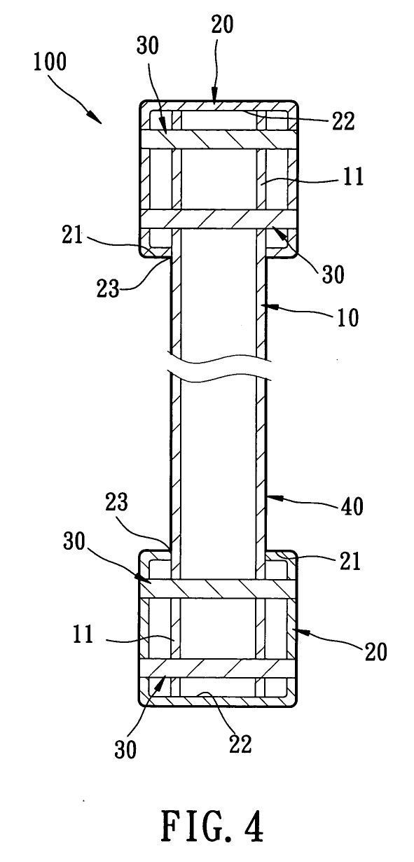

Referring to FIGS. 2, 3 and 4, the preferred embodiment of a method for making a metallic building structure 100, such as railing, having two metal rails 20 interconnected by a plurality of posts 10 includes the steps of:

A) Post-Inserting:

Two metal rails 20 and a plurality of posts 10 are prepared. Each of the metal rails 20 is hollow and has a substantially rectangular cross section. Each of the metal rails 20 has a sidewall 21 provided with a plurality of spaced-apart insert holes 23 and an inner wall surface 22 opposite to the sidewall 21. Each of the posts 10 is hollow, has a substantially rectangular cross section that is smaller than that of each of the metal rails 20, and is configured to correspond in size and shape to a respective one of the insert holes 23. Each of the posts 10 has two ends 11 which are respectively inserted into the corresponding insert holes 23 of the metal rails 20 such that the ends 11 abut against the inner wall surfaces 22 of the metal rails 20, respectively, and such that the sidewalls 21 of the metal rails 20 face toward each other and the posts 10 are parallel to each other.

B) Pin-Inserting:

Two pins 30 are inserted through a corresponding one of the metal rails 20 and one of the ends 11 of a corresponding one of the posts 10 such that two opposite ends of each of the pins 30 protrude from two opposite sides of the corresponding one of the metal rails 20.

C) Welding:

The ends of each of the pins 30 are welded to a corresponding one of the metal rails 20.

D) Grinding:

The welded parts of the pins 30 and the metal rails 20 are ground so that the metal rails 20 have smooth outer surfaces.

E) Conducting an Anti-Rusting Surface Treatment:

An anti-rusting surface treatment is conducted on the metal rails 20 and the posts 10. The anti-rusting surface treatment can be conducted by painting or galvanizing, or by galvanizing followed by painting. An anti-rusting protective layer is provided on the outer surfaces of the metal rails 20 and the posts 10 after the treatment.

The metallic building structure 100 thus made according to the aforesaid method includes two metal rails 20, a plurality of posts 10, a plurality of pins 30, and a protective layer 40. Each of the metal rails 20 has a plurality of spaced-part insert holes 23. Each of the posts 10 has two opposite ends 11 respectively inserted into two corresponding ones of the insert holes 23 formed in the two metal rails 20. Two of the pins 30 extend through a corresponding one of the metal rails 20 and one of the ends 11 of a corresponding one of the posts 10. Each of the pins 30 has two ends flush with an outer surface of the corresponding one of the metal rails 20. The anti-rusting protective layer 40 is coated on the metal rails 20 and the posts 10.

In the present invention, since the posts 10 are first inserted into the metal rails 20, and are subsequently fastened to the metal rails 20 by the pins 30, the integral structure of the metallic building structure 100 is improved in terms of mechanical strength. Furthermore, grinding of the welded parts of the pins 30 which protrude from the outer surfaces of the metal rails 20 is easier to conduct, and will not result in damage to structural strength of the metallic building structure 100. Additionally, the metallic building structure 100 can have a nice and smooth appearance after grinding and coating.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A method for making a metallic building structure which has at least one metal rail connected to a plurality of posts, said method comprising the steps of:
a)inserting one end of at least one of said posts into an insert hole of said metal rail;
b) inserting a pin through said metal rail and said end of said at least one of said posts such that two opposite ends of said pin protrude from two opposite sides of said metal rail;
c) welding said ends of said pin to said metal rail;
d) grinding welded parts of said pin and said metal rail so as to provide a smooth surface; and
e) conducting an anti-rusting surface treatment on said metal rail and said at least one of said posts.

2. The method as claimed in claim 1, wherein the step e) is conducted by painting.

3. The method as claimed in claim 1, wherein the step e) is conducted by galvanizing.

4. The method as claimed in claim 1, wherein the step e) is conducted by galvanizing followed by painting.

5. A metallic building structure, comprising:
at least one metal rail having a plurality of insert holes;
a plurality of posts each having an end inserted into one of said insert holes; and
a plurality of pins each being inserted through said at least one metal rail and said end of a corresponding one of said posts, said pins having two ends flush with an outer surface of said metal rail.

6. The metallic building structure as claimed in claim 5, further comprising a protective layer coated on said metal rail and said posts.

7. The metallic building structure as claimed in claim 6, wherein said protective layer is an anti-rusting layer.
